(19) United States
(12) Patent Application Publication
(10) Pub. No.: US 2010/0320287 A1
(43) Pub. Date: Dec. 23, 2010

(54) Inverted Spray Paint System Using Compressed Air

(76) Inventor: Christopher Heatley, McHenry, IL (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 12/485,971

(22) Filed: Jun. 17, 2009

(51) Int. Cl. B05B 9/04; B05B 1/00

(52) U.S. Cl. 239/147; 239/373; 239/600

(57) ABSTRACT

A spray paint system for spraying a horizontal surface having a frame supporting an inverted elongated rigid container configured to hold a paint formulation that is pressurized with a pumping device partially located within the container where the frame has at least one wheel to allow a user to roll the system along a horizontal surface while spraying paint through a removable spray tip. This system can be used to mark a horizontal surface with precise and clear writing of lines, letters or symbols.

### BACKGROUND OF THE INVENTION

My invention relates to a spray paint system that does not require the use of traditional organic based propellants in the paint mixture. My system uses an inverted or substantially vertical container where a paint formulation in liquid form occupies the lower section of the container and compressed air occupies an upper portion of the container above the paint mixture. Pressurizing the air in the space above the paint forces the paint out through a replaceable nozzle or tip that is attached to the lower end of the container. The spray paint system has a variety of uses all involving an inverted position relative to standard spray painting applications, such as marking objects, specifically making precise pin point markings, such as letters or symbols, on horizontal objects, such as athletic playing fields, roadways, buildings, walkways, etc. Such marking can assist construction or utility repair crews and the like.

Many spray paint systems are known and generally fall into two categories. The ubiquitous aerosol can of spray paint is well known. In this system a paint mixture and a propellant, typically an easily vaporized hydrocarbon or other organic based compound, are injected into the can under pressure. The paint and propellant are discharged through a valve attached to the top of the can when held in an upright orientation. Such systems only contain organic compounds as the propellant, which are mixed with the paint formulation. Once the propellant is exhausted from the can no more paint can be removed, thus making for a wasteful situation. Additionally, these aerosol spray paint cans are costly to manufacture, present a disposal problem, and typically use high cost hydrocarbon propellants that can be harmful to the environment.

The second known spray paint system is where a paint formulation is added directly to a rigid container at ambient pressure (no propellant mixed with the paint formulation). The container is then pressure sealed and a source of pressurized fluid, typically compressed air, is regulated through an inlet into the container causing the paint formulation to pressurize above atmospheric pressure. The container is held in an upright position and a trigger mechanism is activated so that pressurized paint is then forced out of the rigid container through an attached hose and then through a special spray nozzle with combined valve means that is designed to atomize the entrained paint particles. Such systems only operate in an upright position. A variant of this system uses a venturi to entrain paint in a high-pressure air stream.

My invention eliminates the disadvantages of these known spray paint systems through the use of an inverted spray paint system that can be pressurized using only air.

These and other advantages will be apparent from the following detailed discussion of my invention and the appended claims.

### SUMMARY OF THE INVENTION

My invention is an improved spray paint system that does not require the use of a traditional hydrocarbon propellant and instead uses an inverted elongated cylindrical container pressurized with air using a pump that is partially contained within the container. Specifically, one embodiment of my invention comprises, in combination, an inverted spray paint system having a rigid elongated container having an interior space, a first opening located at an upper end of the container and a second opening located at a lower end of the container. A paint mixture can be located in the interior space at the lower end of the interior space of the container. The lower end is defined as the end closest to the ground. The upper end of the interior space (opposite the lower end) contains a portion of a pumping device that sits above the paint mixture. The pumping means is used to pressurize the space above atmospheric pressure in order to force the paint formulation out through the second opening. The system also has at least one cap configured to releasably attach the pumping device to the upper end of the container and to allow introduction of a liquid paint mixture into the container. The system has a removable spray tip in fluid communication with the second opening of the rigid container that allows for egress of the paint mixture in a spray pattern upon activation of a trigger operably connected to the rigid container.

In yet another embodiment of my invention, a spray paint system is provided comprising, in combination, a rigid elongated container having an interior space, a first opening located at an upper end of the container and a second opening located at a lower end of the container. A frame that supports the elongated container has a frame handle located near the upper end of the elongated container to assist a user of the system to move the container while spray painting a horizontal surface. This embodiment also has a pumping device partially contained in the upper end of the interior space of the elongated container and has a pump handle connected to the pumping device configured to allow a user to manually activate the pumping device to pressurize the interior space to a pressure greater than atmospheric pressure. The frame has at least one wheel mounted to it near the lower end of the container to allow a user to roll the spray paint system along a horizontal surface during paint application. A removable spray tip in fluid communication with the second opening of the elongated container is configured to allow a pressurized paint formulation within the interior space to exit the elongated container in a spray pattern directed onto a horizontal surface as a user moves the painting system using the wheel. There also is a trigger positioned near the upper end of the elongated container that is operably connected to the container and is used to activate delivery of a pressurized paint mixture through the spray tip.

My invention can also be configured where the trigger is operably connected to the spray tip and preferably where the trigger is connected to a cable that is operably connected to a valve in the spray tip. In order to keep the spray paint system in a generally vertical position when not rolling or moving the system it is preferred to include a vertical stabilizer near the lower end of the container attached to either the frame, the container or to both. The pumping device is preferably a self-contained assembly that can be removed from the container and that has a handle accessible to a using for manually activating the pump. The pump can be connected to the container through the first opening in the upper end of the container. The spray paint system can also include a pressure indicator in fluid communication with the container to show the user the pressure level in the container. Likewise, the system can include a pressure relief valve in fluid communication with the container as a safety feature to prevent over pressuring of the system.

Regardless of the mechanical configuration of my spray paint system, an important aspect of my invention is that the only propellant used is compressed air. The system does not contain any volatile compounds, such as hydrocarbons.

Although a preferred pumping device is self-contained within the system of my invention, for example a hand pump, it can also be a completely external pumping means, such as a gas powered compressor that can add compressed air to the system. In either case the pumping device is in communication with the first opening to create the pressurized air above the paint mixture. The pressure source can comprise any known means to generate a fluid under pressure, for example a pump or cylinder of compressed gas. If a pump is used, then it can be battery operated, similar in design to battery operated power tools, or it can be powered using a conventional AC power source.

My spray paint system is to be used only in a generally downward direction with the paint formulation being dispensed through a spray tip or nozzle located at the lower end of the container. Control of the paint flow is accomplished by controlling pressure within the elongated container, by opening and closing a valve in fluid communication with the spray tip, or a combination of both. A trigger or valve or other regulation means that is in fluid communication with the source of pressurized fluid or with the pressurized paint mixture can accomplish this. Increasing or maintaining a given pressure within the elongated container will work to continuously force the paint out through the discharge opening and the spray tip. Decreasing or stopping the pressure in the container will slow or stop the rate of paint flow.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a schematic representation showing a side view of one embodiment of my invention.

FIG. 2 is a schematic representation showing a front view of the embodiment illustrated in FIG. 1

FIG. 3 is a schematic representation of one embodiment of a self-contained hand pump that can be inserted into the elongated cylinder of my invention.

FIG. 4 is a schematic representation showing a front view of a second of one embodiment of my invention.

### DETAILED DESCRIPTION OF THE PREFERRED EMBODIMENT

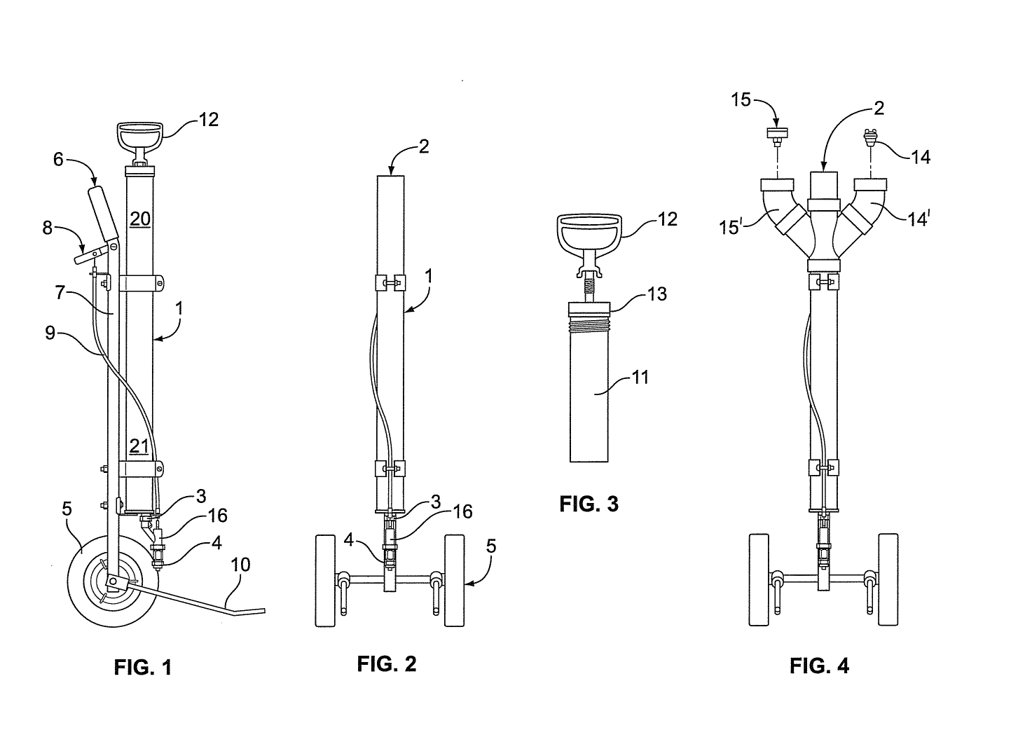

Referring now to FIGS. 1-2, which shows just one of many possible configurations, sizes, and shapes of the elongated container 1 of my spray paint system, the container is preferably fabricated from any material of construction that can withstand pressures greater than atmospheric, preferably in the range of from about 20 psig to about 120 psig. Rigid plastics, glass, metal or like materials will all be acceptable. Container 1 has an interior space, a first opening 2 and a second opening 3. The upper end 20 of the interior space accepts or receives pumping device 11 (see FIG. 3), which includes a hand pump 12 that is used to manually operate the pump to pressurize the interior space above atmospheric pressure. As the pump handle is stroked by a user air is forced into the upper section of the interior space and subject to compressive forces, which continually increases the pressure in the upper end of the container.

The container also has a lower end 21 that holds a liquid paint mixture added through opening 2. First opening 2 is configured to allow the pump device to be placed in the interior of rigid container 1 and then sealed within using cap 13. Cap 13 is removable to allow removal of the pump and access to the interior space of the container. Cap 13 can connect with container 1 through connection means, which can be any known type of connection that will maintain applied pressure to the interior of container 1, for example, screw threads, snap lock, bayonet fitting, snap lock released through threads, claps, and the like connections. Second opening 3 allows a pressurized fluid, such as compressed air, nitrogen, carbon dioxide, and the like, to be introduced to the interior of container 1. Optionally, container 1 may have a relief valve 14 (see FIG. 4) secure in opening 14′ to vent excess pressurized fluid from the interior if an over-pressurization occurs. Additionally, the container may have a pressure gauge 15 secure in opening 15′ to allow the user to monitor the pressure within the container.

When the air in the upper end of the interior of the rigid container is pressurized, which creates a force exerted on the paint mixture that will cause it to exit the lower end of the container through discharge or second opening 3. To control the discharge or spray pattern of the exiting paint, a spray tip or nozzle 4 is connected to discharge opening 3. Preferably tip 4 is removable and can also be disposable. One possible design includes a nozzle 4 that is capable of accepting a tip insert (not shown) to allow for very fine painting of numbers and letters. The insert can be releasably connected to the spray nozzle through any connection type known to the art provided that the insert can be disconnected and re-connected without damaging the insert or the spray nozzle 4. Preferred connections would include a screw fitting, snap-lock, press fit, luer-lock, bayonet, quick disconnect, or any other known releasable connector. For ease and speed of connection the most preferred connector is a press fit connection.

Although a specific type of pump is shown in the embodiment in the Figures the pump can also be configured as a battery or AC operated device or other pressure device, such as a small cylinder of compressed gas that can supply a pressurized fluid (air or other gas) through the first opening 2 or through another opening located in the upper end of the container. In some circumstances it may be convenient to design the pump to accept power in the form of DC current supplied by a cigarette lighter or other power connector now typically available in most automobiles, trucks or other vehicles. The spray paint system also comprises a frame 7 that holds or supports (both permanently or removably) container 1. The frame can be composed of any structural material, such as plastic or metal that will adequately support the container. Preferably the frame has a handle 6 that allows the user to move the system along a horizontal surface using one or more wheels 5 attached to either the frame or the container.

The frame could also have one or more vertical stabilizers 10 to maintain the system in a substantially upright position when not being moved along a horizontal surface. The system also preferably has a trigger or actuator 8 to cause the paint to be sprayed through nozzle 4. Preferably the trigger is located near the upper end of the container near the handle to allow convenient access to the user when pushing or pulling the system along a horizontal surface. Most preferably, the trigger is connected via cable 9 or other linkage to valve 16 in fluid communication with the interior space and the nozzle. Once the upper end of the interior space of the container has been pressurized with ambient air using the pumping device, the user will activate the trigger to open the valve to allow the paint to spray outward through the nozzle. The percentage opening of the valve dictates the flow rate of paint through the discharge opening of the container and spray tip.

It is important that the elongated container is positioned in an inverted and vertical position so the paint formulation can be sprayed onto horizontal objects, especially those located on or near ground level. My invention can be used to mark objects such as athletic fields that require precise lines of 4 to 5 inches with crisp edges. Other uses include roadways, walkways, yards, buildings or other structures for construction, survey, safety, or the like purposes.

The invention has been described with reference to a preferred embodiment. Obviously, modifications and alterations will occur to others upon reading and understanding the preceding specification. It is intended that the invention be construed as including all such alterations and modifications insofar as they come within the scope of the appended claims or the equivalents thereof.

I claim:

1. An inverted spray paint system comprising, in combination, the following;
a. a rigid elongated container having an interior space, a first opening located at an upper end of the container and a second opening located at a lower end of the container;
b. a paint reservoir located in the interior space at the lower end;
c. a pressurizable air pocket located in the interior space at the upper end of the container and above the paint reservoir;
d. a cap configured to releasably attach to the upper end of the container to allow introduction of a paint mixture into the container;
e. a pumping device in communication with the first opening to pressurize the air pocket;
f. a removable spray tip in fluid communication with the second opening of the rigid container; and
g. a trigger operably connected to the rigid container to activate delivery of a paint mixture through the spray tip.

2. The spray paint system of claim 1 wherein the pumping device comprises a hand activated pump at least partially located in the interior space.

3. The spray paint system of claim 1 wherein the pumping device is powered by a battery.

4. The spray paint system of claim 1 wherein the system further comprises a frame.

5. The spray paint system of claim 1 wherein the system comprises at least one wheel for rolling along a surface to be painted.

6. A spray paint system comprising, in combination, the following;
a. a rigid elongated container having an interior space, a first opening located at an upper end of the container and a second opening located at a lower end of the container;
b. a frame supporting the elongated container having a frame handle located near the upper end of the elongated container;
c. a pumping device partially contained in the upper end of the interior space of the elongated container;
d. a pump handle connected to the pumping device configured to allow a user to manually activate the pumping device to pressurize the interior space to a pressure greater than atmospheric;
e. at least one wheel mounted to the frame near the lower end of the container configured to allow a user to move the container along a horizontal surface;
f. a removable spray tip in fluid communication with the second opening of the container configured to allow a pressurized paint formulation within the interior space to exit the container in a spray pattern directed onto a horizontal surface as a user moves the container using the wheel; and
g. a trigger positioned near the upper end of the container and operably connected to the container to activate delivery of a pressurized paint mixture through the spray tip.

7. The spray paint system of claim 6 where the trigger is operably connected to the spray tip.

8. The spray paint system of claim 6 where the trigger is connected to a cable that is operably connected to a valve in the spray tip.

9. The spray paint system of claim 6 further comprising a vertical stabilizer configured to maintain the container in a substantially upright position when not moving across a horizontal surface.

10. The spray paint system of claim 6 where the pumping device is removably connected to the first opening in the container.

11. The spray paint system of claim 6 further comprising a pressure indicator in fluid communication with the container.

12. The spray paint system of claim 6 further comprising a pressure relief valve in fluid communication with the container.
